(19) United States
(12) Patent Application Publication
(10) Pub. No.: US 2025/0050300 A1
(43) Pub. Date: Feb. 13, 2025

(54) SYNTHESIS SYSTEM

(71) Applicants: SHIMADZU CORPORATION, Kyoto (JP); WASEDA UNIVERSITY, Tokyo (JP)

(72) Inventors: Yusuke NAGAI, Kyoto (JP); Yosuke IWATA, Kyoto (JP); Takeo SUGA, Tokyo (JP)

(73) Assignees: SHIMADZU CORPORATION, Kyoto (JP); WASEDA UNIVERSITY, Tokyo (JP)

(21) Appl. No.: 18/793,757

(22) Filed: Aug. 3, 2024

(30) Foreign Application Priority Data
Aug. 9, 2023 (JP) 2023-130174

(51) Int. Cl. B01J 19/00

(52) U.S. Cl. CPC B01J 19/004

(57) ABSTRACT

A synthesis system includes a first flow-path portion, a second flow-path portion, a third flow-path portion and a switcher. The first flow-path portion is connected to a first container in which a liquid raw material is containable. The second flow-path portion is connected to a second container in which a liquid raw material is containable. The third flow-path portion connects the first container and the second container to each other. To the third flow-path portion, a synthesis reaction device that produces a reactant from a liquid raw material is connected. The switcher is switchable between a flow-path state in which gas supplied by a gas supplier is guided to the first flow-path portion and a flow-path state in which gas supplied by the gas supplier is guided to the second flow-path portion.

### BACKGROUND

### Technical Field

The present disclosure relates to a synthesis system.

### Description of Related Art

By synthesis such as polymerization, a reactant such as a drug, food or a chemical substance is produced from a raw material (see JP 6733985 B2, for example). In recent years, flow synthesis has been performed as a synthesis method of producing a reactant from a raw material.

### SUMMARY

In a synthesis system for performing flow synthesis, it is conceivable to dispose a photopolymerization reaction device between two containers. A worker connects a supply device for supplying an inert gas to one of the containers. In this case, an inert gas is supplied to one container, and a raw material contained in the container is pumped to the other container through the photopolymerization reaction device. In the photopolymerization reaction device, a reactant is produced from part of a raw material when the raw material is irradiated with light for a certain period of time. Therefore, the other container contains the mixture of the reactant and the unreacted raw material.

Thereafter, the worker connects the supply device for supplying an inert gas to the other one of the containers. In this case, an inert gas is supplied to the other container, and a raw material contained in the container is pumped to the one container through the photopolymerization reaction device. Thus, in the one container, the mixture of the reactant and the remaining unreacted raw material is contained. This operation is repeated, so that a sufficient amount of reactant is produced.

However, in the above-mentioned process of producing a reactant, because it is necessary to repeat light emission to a raw material several tens of times, it is a heavy burden on the worker. Therefore, it is desired to develop a synthesis system capable of reducing a burden on the worker.

An object of the present disclosure is to provide a synthesis system capable of reducing a burden on a worker.

One aspect of the present disclosure relates to a synthesis system that includes a first flow-path portion connected to a first container in which a liquid raw material is containable, a second flow-path portion connected to a second container in which a liquid raw material is containable, a third flow-path portion which connects the first container and the second container to each other and to which a synthesis reaction device is connected, the synthesis reaction device producing a reactant from a liquid raw material, and a switcher that is switchable between a flow-path state in which gas supplied by a gas supplier is guided to the first flow-path portion and a flow-path state in which gas supplied by the gas supplier is guided to the second flow-path portion.

With the present disclosure, it is possible to reduce a burden on a worker in flow synthesis.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a diagram showing the configuration of a synthesis system according to one embodiment of the present disclosure;

FIG. 2 is a diagram for explaining an operation of the synthesis system;

FIG. 3 is a diagram for explaining the operation of the synthesis system;

FIG. 4 is a diagram for explaining the operation of the synthesis system;

FIG. 5 is a diagram for explaining the operation of the synthesis system;

FIG. 6 is a diagram showing the configuration of a controller;

FIG. 7 is a flowchart showing one example of the algorithm of a synthesis process executed by the controller of FIG. 6;

FIG. 8 is a diagram showing the configuration of a synthesis system according to a first modified example;

FIG. 9 is a diagram showing the configuration of a synthesis system according to a second modified example; and

FIG. 10 is a diagram showing the configuration of a synthesis system according to a third modified example.

### DETAILED DESCRIPTION

### (1) CONFIGURATION OF SYNTHESIS SYSTEM

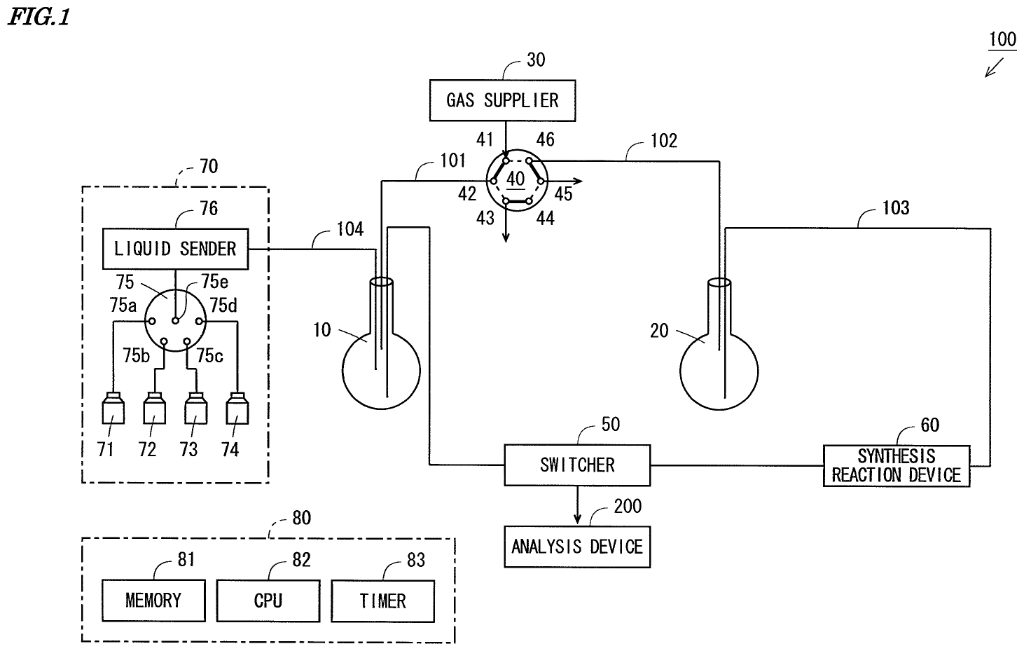

A synthesis system according to embodiments of the present disclosure will be described below in detail with reference to the drawings. FIG. 1 is a diagram showing the configuration of a synthesis system according to one embodiment of the present disclosure. As shown in FIG. 1, the synthesis system 100 is connected to an analysis device 200. The analysis device 200 includes a separation device. Although being a liquid chromatograph in the present embodiment, the analysis device 200 may be another analysis device.

The synthesis system 100 includes containers 10, 20, a gas supplier 30, switchers 40, 50, a synthesis reaction device 60, a sample supplier 70 and a controller 80. Further, the synthesis system 100 includes flow-path portions 101 to 104. The flow-path portions 101 to 103 are examples of first to third flow-path portions, respectively. Each of the flow-path portions 101 to 104 may be formed of one or a plurality of pipes.

The containers 10, 20 are examples of first and second containers, respectively. Each of the containers 10, 20 is a flask, for example, and can contain a liquid raw material. In the present embodiment, the liquid raw material is a monomer. The gas supplier 30 supplies a nitrogen gas. The gas supplier 30 may supply another inert gas or gas such as a clean air.

The switcher 40 is a multi-way switching valve, for example, and has six ports 41 to 46. The switcher 40 is an example of a switcher, and can be switched between a first flow-path state and a second flow-path state. In the first flow-path state, the ports 41, 42 are connected to each other, the ports 43, 44 are connected to each other, and the ports 45, 46 are connected to each other. In the second flow-path state, the ports 42, 43 are connected to each other, the ports 44, 45 are connected to each other, and the ports 46, 41 are connected to each other.

The port 41 is connected to the gas supplier 30. The port 42 is connected to the container 10 through the flow-path portion 101. The ports 43, 45 are open to an atmosphere. The port 46 is connected to the container 20 through the flow-path portion 102. With this connection, in the first flow-path state, the gas supplied by the gas supplier 30 is guided to the container 10 through the flow-path portion 101. In the second flow-path state, the gas supplied by the gas supplier 30 is guided to the container 20 through the flow-path portion 102.

The container 10 and the container 20 are connected to each other by the flow-path portion 103. In the flow-path portion 103, the switcher 50 and the synthesis reaction device 60 are provided. The switcher 50 is connected to the analysis device 200. The switcher 50 is a multi-way switching valve similar to the switcher 40, and is switchable between a third flow-path state and a fourth flow-path state. In the third flow-path state, liquid is guided between the container 10 and the container 20. In the fourth flow-path state, liquid flowing through the flow-path portion 103 is guided to the analysis device 200. Here, the liquid includes a liquid raw material or a reactant, described below.

A liquid raw material flowing through the flow-path portion 103 passes through the synthesis reaction device 60 over a certain period of time while remaining. The synthesis reaction device 60 causes the liquid raw material passing through the synthesis reaction device 60 to react, thereby producing a reactant from the liquid raw material. In the present embodiment, the synthesis reaction device 60 is a photopolymerization reaction device and includes a light source capable of emitting ultraviolet rays. The liquid raw material passing through the synthesis reaction device 60 is irradiated with ultraviolet rays, so that a high molecular polymer is produced as a reactant.

The sample supplier 70 includes a plurality (four in the example of FIG. 1) of bottles 71 to 74, a switcher 75 and a liquid sender 76. The bottle 71 contains a liquid raw material for replenishment. Each of the bottles 72 to 74 contains a liquid additive. The switcher 75 includes five ports 75a to 75e and is switchable to any of fifth to eighth flow-path states. In the fifth flow-path state, the port 75a is connected to the port 75e. In the sixth flow-path state, the port 75b is connected to the port 75e. In the seventh flow-path state, the port 75c is connected to the port 75e. In the eighth flow-path state, the port 75d is connected to the port 75e.

The ports 75a to 75d are connected to the bottles 71 to 74, respectively. The port 75e is connected to the liquid sender 76. With this connection, in the fifth flow-path state, the liquid raw material contained in the bottle 71 is guided to the liquid sender 76. In the sixth flow-path state, the liquid additive contained in the bottle 72 is guided to the liquid sender 76. In the seventh flow-path state, the liquid additive contained in the bottle 73 is guided to the liquid sender 76. In the eighth flow-path state, the liquid additive contained in the bottle 74 is guided to the liquid sender 76.

The liquid sender 76 includes a pump, for example, and supplies the liquid raw material or the liquid additive guided by the switcher 75 to the container 10 through the flow-path portion 104. Thus, the container 10 can be replenished with the liquid raw material. Alternatively, a liquid additive can be added to the liquid raw material in the container 10. The liquid sender 76 may be connected to the container 20 by the flow-path portion 104. In this case, the liquid sender 76 supplies the liquid raw material or the liquid additive guided by the switcher 75 to the container 20 through the flow-path portion 104.

The controller 80 includes a memory 81 and a CPU (Central Processing Unit) 82. Further, in the present embodiment, the controller 80 further includes a timer 83 for measuring an elapsed period of time. The memory 81 stores a synthesis program for producing a reactant from a liquid raw material. In accordance with the synthesis program stored in the memory 81, the CPU 82 controls the operations of the gas supplier 30, the switchers 40, 50, the synthesis reaction device 60 and the sample supplier 70. Details of the controller 80 will be described below.

### (2) OPERATION OF SYNTHESIS SYSTEM

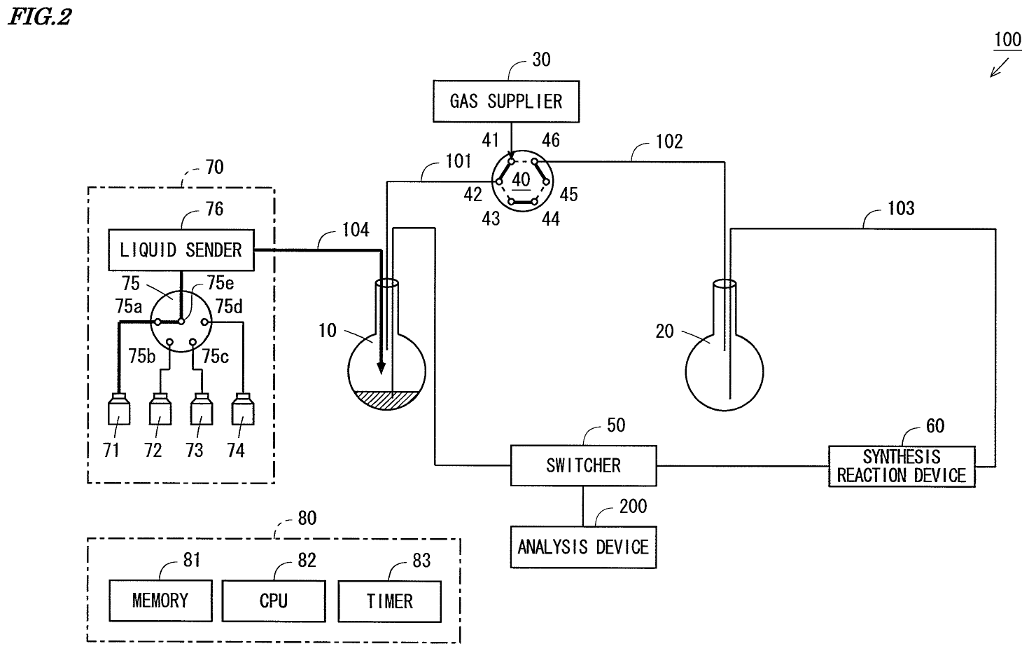

FIGS. 2 to 5 are diagrams for explaining the operation of the synthesis system 100. In an initial state of the synthesis system 100, a liquid raw material is not contained in either of the containers 10, 20. As such, the flow-path state of the switcher 75 of the sample supplier 70 is switched to the fifth flow-path state, and the liquid sender 76 is driven. In this case, as indicated by the thick solid arrow in FIG. 2, the liquid raw material contained in the bottle 71 is pumped to the container 10 through the flow-path portion 104. After a predetermined period of time has elapsed, the driving of the liquid sender 76 is stopped. Thus, a certain amount of the liquid raw material is contained in the container 10.

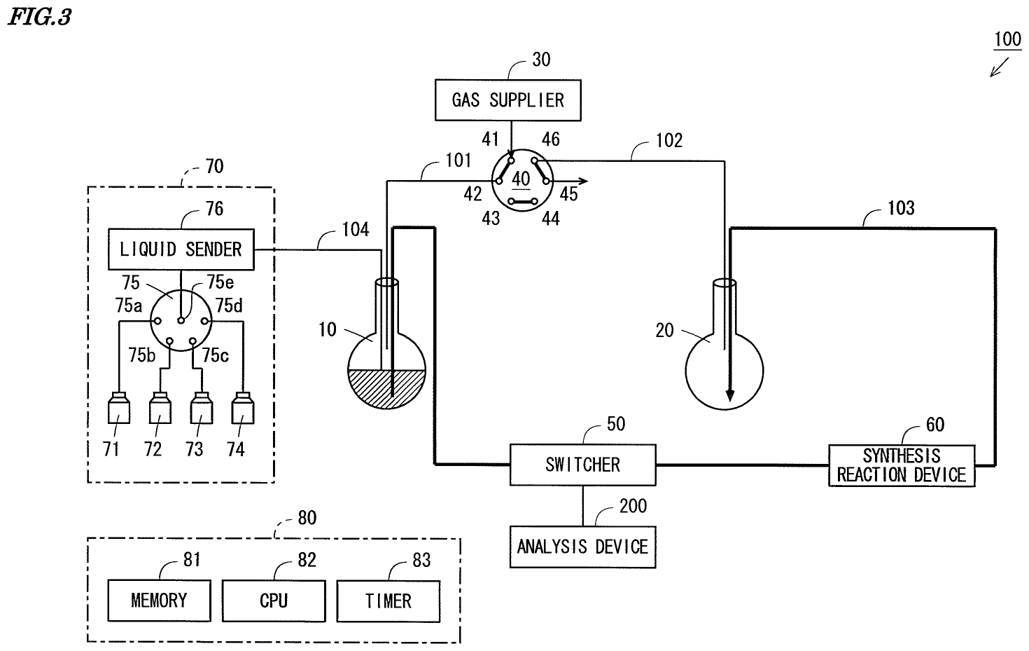

Next, the flow-path state of the switcher 40 is switched to the first flow-path state, and the flow-path state of the switcher 50 is switched to the third flow-path state. In this state, the gas supplier 30 is driven. In this case, the gas supplied by the gas supplier 30 is guided to the container 10 through the flow-path portion 101, so that the liquid raw material contained in the container 10 is pumped to the container 20 through the flow-path portion 103 as indicated by the thick solid arrow in FIG. 3. The gas supplied to the container 10 is discharged to an atmosphere through the flow-path portion 103, the container 20, the flow-path portion 102 and the ports 46, 45 of the switcher 40 in this order.

In the flow-path portion 103, the liquid raw material passes through the synthesis reaction device 60, so that part of the liquid raw material reacts. Thus, a reactant is produced from part of the liquid raw material. Therefore, the container 20 contains liquid (hereinafter simply referred to as a liquid raw material) obtained when an unreacted liquid raw material and a reacted reactant are mixed.

Thereafter, in a case in which a switching condition for the flow-path state of the switcher 40 is satisfied, the flow-path state of the switcher 40 is switched from the first flow-path state to the second flow-path state. The switching condition for the flow-path state of the switcher 40 is that the liquid amount in each of the containers 10, 20 is equal to or smaller than a predetermined value, for example. Therefore, when the liquid amount in the container 10 becomes equal to or smaller than the predetermined value, the flow-path state of the switcher 40 is switched from the first flow-path state to the second flow-path state.

A worker may specify the period of time until the liquid amount in each of the containers 10, 20 becomes equal to or smaller than the predetermined value by experiment, calculation or the like, and set the specified period of time in the controller 80. In this case, when the period of time measured by the timer 83 reaches the set period of time, it is determined that the liquid amount in the container 10, 20 is equal to or smaller than the predetermined value, and the flow-path state of the switcher 40 is 30 switched.

Alternatively, the switching condition for the flow-path state of the switcher 40 is that the liquid amount in each of the containers 10, 20 is equal to or larger than a predetermined value, for example. Therefore, when the liquid amount in the container 20 becomes equal to or larger than the predetermined value, the flow-path state of the switcher 40 is switched from the first flow-path state to the second flow-path state. Also in this case, the worker may specify the period of time until the liquid amount in each of the containers 10, 20 becomes equal to or larger than the predetermined value by experiment, calculation or the like, and set the specified period of time in the controller 80. In this case, when the period of time measured by the timer 83 reaches the set period of time, it is determined that the liquid amount in each of the containers 10, 20 is equal to or larger than the predetermined value, and the flow-path state of the switcher 40 is switched.

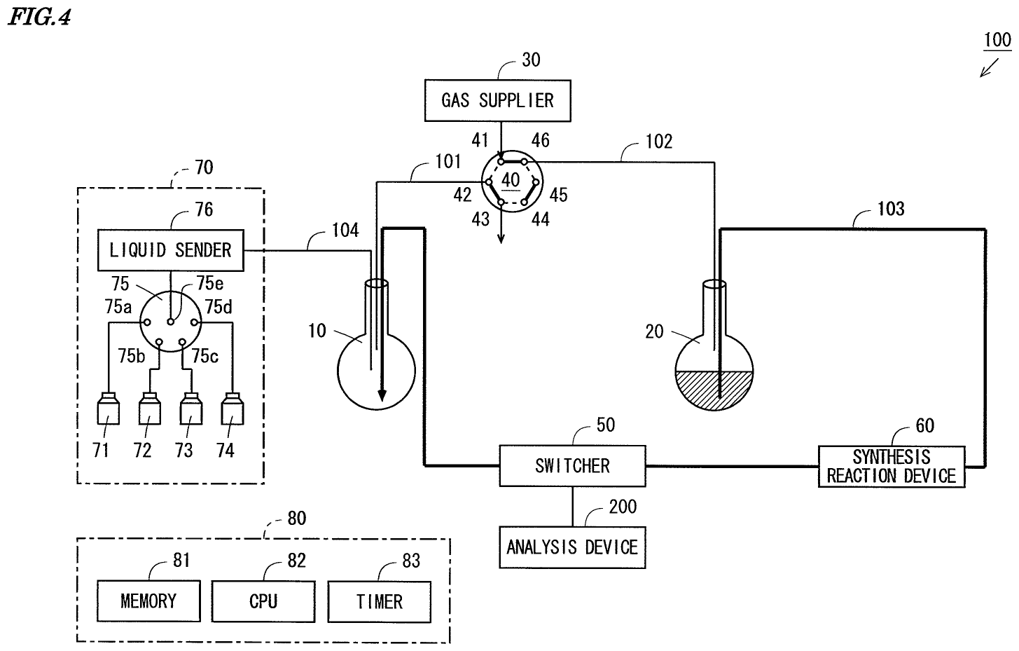

When the flow-path state of the switcher 40 is switched to the second flow-path state, the gas supplied by the gas supplier 30 is guided to the container 20 through the flow-path portion 102. In this case, as indicated by the thick solid arrow in FIG. 4, the liquid raw material contained in the container 20 is pumped to the container 10 through the flow-path portion 103. The gas supplied to the container 20 is discharged to an atmosphere through the flow-path portion 103, the container 10, the flow-path portion 101 and the ports 42, 43 of the switcher 40 in this order.

In the flow-path portion 103, the liquid raw material passes through the synthesis reaction device 60, so that part of the unreacted liquid raw material reacts. Thus, a reactant is further produced from part of the unreacted liquid raw material. Therefore, in the container 10, the liquid obtained when an unreacted liquid raw material and a reacted reactant are mixed is contained.

Thereafter, in a case in which the switching condition for the flow-path state of the switcher 40 is satisfied, the flow-path state of the switcher 40 is switched from the second flow-path state to the first flow-path state. Thus, the operation of FIG. 3 and the operation of FIG. 4 are alternately repeated. Each time these operations are repeated, an amount of reactant in the liquid raw material contained in the container 10 or the container 20 increases.

In a case in which the liquid raw material contained in the container 10 is reduced, the container 10 may be suitably replenished with the liquid raw material by switch of the switcher 75 to the fifth flow-path state and driving of the liquid sender 76 in the sample supplier 70. Further, in the stage where reaction of the liquid raw material has proceeded to a certain extent, a predetermined additive may be supplied to the container by switch of the switcher 75 to any of the sixth to eighth flow-path states and driving of the liquid sender 76. This can promote the reaction.

Thereafter, in a case in which the switching condition for the flow-path state of the switcher 50 is satisfied, the flow-path state of the switcher 50 is switched from the third flow-path state to the fourth flow-path state. In the present embodiment, the switching condition for the flow-path state of the switcher 50 is that an elapsed period of time measured by the timer 83 reaches the period of time set in the controller 80. The worker may specify a period of time until a sufficient amount of reactant is produced by experiment, calculation or the like, and set the specified period of time in the controller 80. In this case, when a sufficient amount of reactant is produced, the flow-path state of the switcher 50 is switched from the third flow-path state to the fourth flow-path state.

Alternatively, the switching condition for the flow-path state of the switcher 50 may be that the number of times of the flow-path state of the switcher 40 is switched reaches the number of times set in the controller 80. The worker may specify, by experiment, calculation or the like, the number of times the flow-path state of the switcher 40 is switched until a sufficient amount of reactant is produced, and set the specified number of times in the controller 80. Also in this case, when a sufficient amount of reactant is produced, the flow-path state of the switcher 50 is switched from the third flow-path state to the fourth flow-path state.

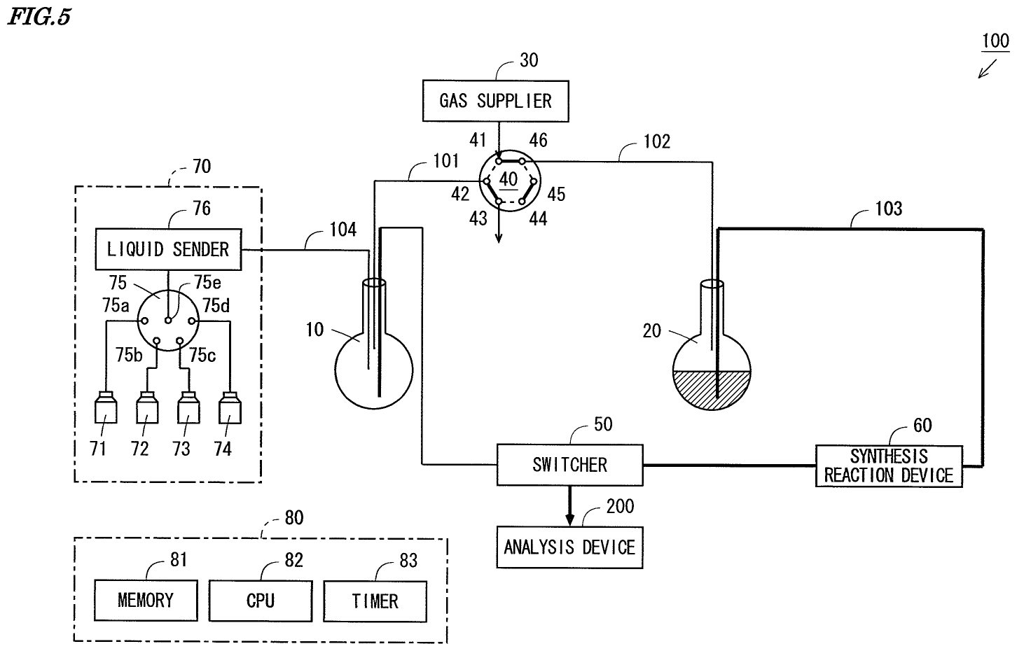

When the flow-path state of the switcher 50 is switched to the fourth flow-path state, the liquid raw material contained in the container 20 is pumped to the analysis device 200 through the flow-path portion 103 as indicated by the thick solid arrow in FIG. 5. Depending on a point in time at which the flow-path state of the switcher 50 is switched to the fourth flow-path state, the liquid raw material contained in the container 10 is pumped to the analysis device 200 through the flow-path portion 103. In the analysis device 200, a reactant produced by the synthesis reaction device 60 is analyzed. Further, the analyzed reactant is collected by the separation device (not shown).

### (3) SYNTHESIS PROCESS

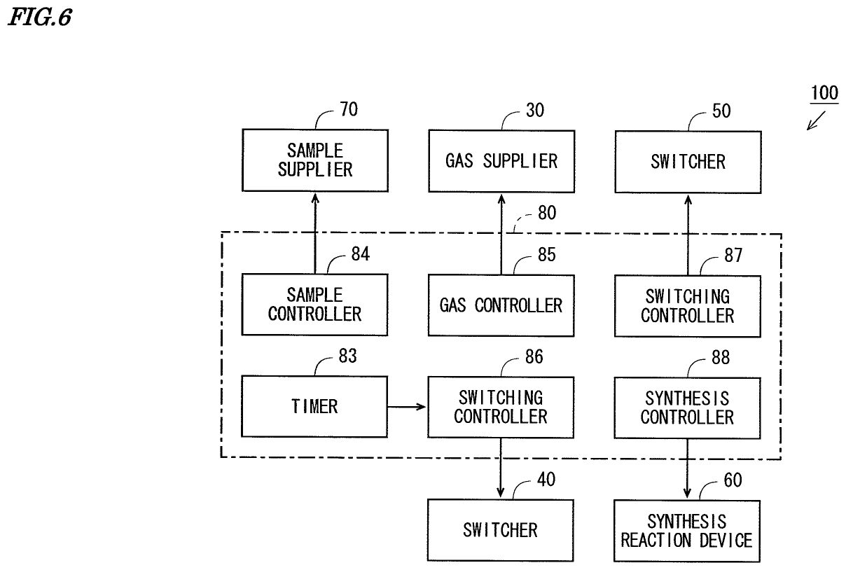

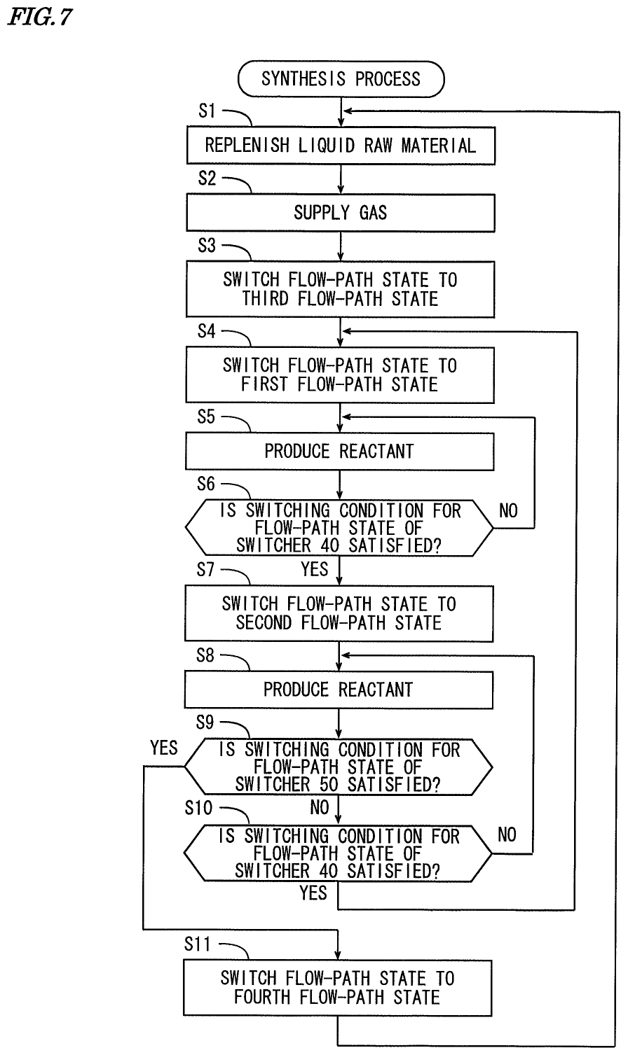

FIG. 6 is a diagram showing the configuration of the controller 80. FIG. 7 is a flowchart showing one example of the algorithm of a synthesis process executed by the controller 80 of FIG. 6. As shown in FIG. 6, the controller 80 includes a sample controller 84, a gas controller 85, switching controllers 86, 87 and a synthesis controller 88 as functions. Functions of the controller 80 are implemented by execution of the synthesis program stored in the memory 81 by the CPU 82 of FIG. 1 of the controller 80. Part or all of the functions of the controller 80 may be realized by hardware such as an electronic circuit.

The synthesis process will be described below with reference to the synthesis system 100 of FIGS. 2 to 5, the controller 80 of FIG. 6 and the flowchart of FIG. 7. First, the sample controller 84 controls the sample supplier 70 to replenish the container 10 with the liquid raw material (step S1 and FIG. 2). In the initial state of the synthesis system 100, in a case in which a liquid raw material is contained in the container 10, the step S1 does not have to be executed.

Next, the gas controller 85 supplies gas using the gas supplier 30 (step S2). Further, the switching controller 87 switches the flow-path state of the switcher 50 to the third flow-path state (step S3). Further, the switching controller 86 switches the flow-path state of the switcher 40 to the first flow-path state (step S4). Either one of the steps S2 to S4 may be executed first, or the steps S2 to S4 may be executed at the same time.

Because the steps S2 to S4 are executed, the liquid raw material contained in the container 10 is pumped to the container 20 through the flow-path portion 103 (FIG. 3). Here, the synthesis controller 88 controls the synthesis reaction device 60 to produce a reactant from the liquid raw material passing through the synthesis reaction device 60 (step S5).

Subsequently, the switching controller 86 determines whether the switching condition for the flow-path state of the switcher 40 is satisfied (step S6). In a case in which the switching condition for the flow-path state of the switcher 40 is not satisfied, the switching controller 86 returns the process to the step S5. The steps S5 and S6 are repeated until the switching condition for the flow-path state of the switcher 40 is satisfied.

In a case in which the switching condition for the flow-path state of the switcher 40 is satisfied, the switching controller 86 switches the flow-path state of the switcher 40 to the second flow-path state (step S7). Thus, the liquid raw material contained in the container 20 is pumped from the flow-path portion 103 (FIG. 4). Here, the synthesis controller 88 controls the synthesis reaction device 60 to produce a reactant from the liquid raw material passing through the synthesis reaction device 60 (step S8).

Thereafter, the switching controller 87 determines whether the switching condition for the flow-path state of the switcher 50 is satisfied (step S9). In a case in which the switching condition for the flow-path state of the switcher 50 is not satisfied, the liquid raw material pumped from the container 20 is guided to the container 10. In this case, the switching controller 86 determines whether the switching condition for the flow-path state of the switcher 40 is satisfied (step S10).

In a case in which the switching condition for the flow-path state of the switcher 40 is satisfied, the switching controller 86 returns the process to the step S4. Thus, the liquid raw material is pumped again from the container 10 to the container 20. At this point in time, the sample controller 84 may replenish the container 10 with the liquid raw material or may add a liquid additive to the liquid raw material in the container 10, by controlling the sample supplier 70. On the other hand, in a case in which the switching condition for the flow-path state of the switcher 40 is not satisfied, the switching controller 86 returns the process to the step S8.

In a case in which the switching condition for the flow-path state of the switcher 50 is satisfied in the step S9, the switching controller 87 switches the flow-path state of the switcher 50 to the fourth flow-path state (step S11). Thus, a reactant produced in the steps S5 and S8 is supplied to the analysis device 200 (FIG. 5). In the analysis device 200, the supplied reactant is analyzed and separated. Thereafter, the process returns to the step S1. Thus, the similar process is repeated. The synthesis process may end after execution of the step S11.

### (4) MODIFIED EXAMPLES

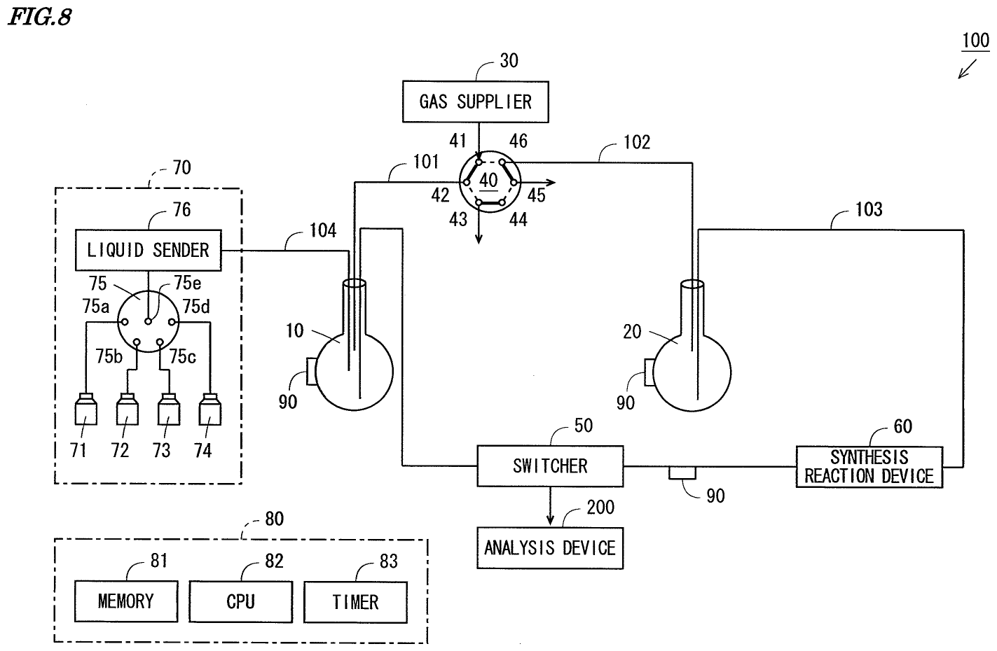

In the synthesis system 100, the temperature of a liquid raw material may be regulated to a temperature suitable for reaction. FIG. 8 is a diagram showing the configuration of a synthesis system 100 according to a first modified example. As shown in FIG. 8, the synthesis system 100 according to the present example includes one or more temperature regulators 90. Each temperature regulator 90 may be a heater or a Peltier element, for example.

In the example of FIG. 8, the temperature regulator 90 is attached to each of a container 10, a container 20 and a flow-path portion 103. Thus, the temperature of a liquid raw material contained in the container 10, the temperature of a liquid raw material contained in the container 20, and the temperature of a liquid raw material flowing through the flow-path portion 103 are regulated by the temperature regulator 90. The temperature regulator 90 does not have to be attached to each of the container 10, the container 20 and the flow-path portion 103, and is only required to be attached to any one of the container 10, the container 20 and the flow-path portion 103. Further, in a case in which the temperature regulator 90 is attached to the flow-path portion 103, it can promote the reaction.

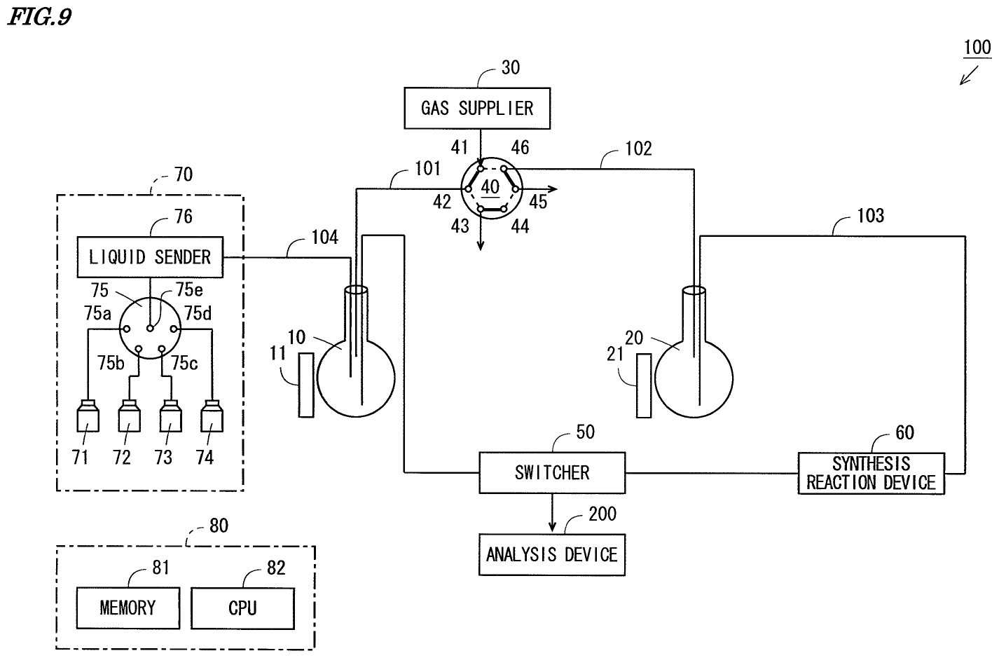

While the flow-path state of the switcher 40 is switched based on an elapsed period of time measured by a timer 83 in the present embodiment, the embodiment is not limited to this. FIG. 9 is a diagram showing the configuration of a synthesis system 100 according to a second modified example. As shown FIG. 9, the synthesis system 100 according to the present example further includes liquid level sensors 11, 21. Further, in the second modified example or a third modified example, described below, a controller 80 does not include a timer 83.

Each of the liquid level sensors 11, 21 detects the liquid level of the liquid raw material contained in each of the containers 10, 20. Each of the liquid level sensors 11, 21 may be a camera that picks up an image of the liquid raw material contained in each of the containers 10, 20, for example. In this case, based on an image of the liquid raw material, the liquid level of the liquid raw material contained in each of the containers 10, 20 is detected.

The worker may set, in the controller 80, the height of the liquid level when the liquid amount in each of the containers 10, 20 is equal to or smaller than a predetermined value, for example. Alternatively, the height of the liquid level when the liquid amount in each of the containers 10, 20 is equal to or smaller than the predetermined value may be set to a specified value in advance. In these cases, when the height of the liquid level detected by each of the liquid level sensors 11, 21 reaches a set height, it is determined that the liquid amount in the container 10 or the container 20 is equal to or smaller than the predetermined value, and the flow-path state of the switcher 40 is switched.

On the other hand, the worker may set, in the controller 80, the height of the liquid level in a case in which the liquid amount in each of the containers 10, 20 is equal to or larger than the predetermined value, for example. Alternatively, the height of the liquid level in a case in which the liquid amount in each of the containers 10, 20 is equal to or larger than the predetermined value may be set to a specified value in advance. In these cases, when the height of the liquid level detected by each of the liquid level sensors 11, 21 reaches a set height, it is determined that the liquid amount in the container 10 or the container 20 is equal to or larger than the predetermined value, and the flow-path state of the switcher 40 is switched.

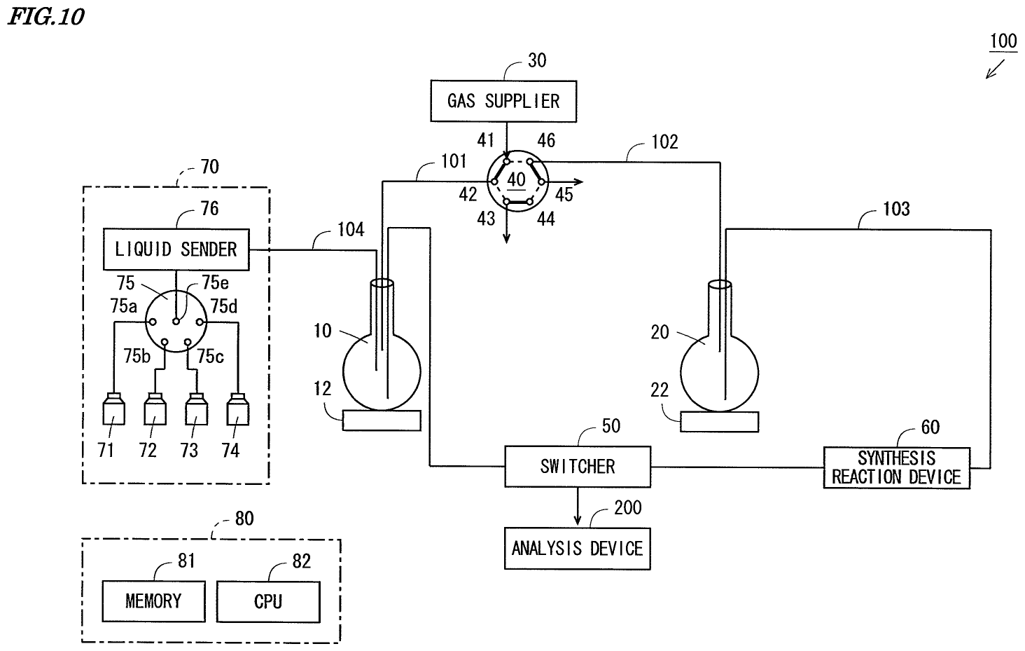

FIG. 10 is a diagram showing the configuration of a synthesis system 100 according to a third modified example. As shown FIG. 10, the synthesis system 100 according to the present example further includes weight sensors 12, 22. Each of the weight sensors 12, 22 detects the weight of the liquid raw material contained in each of the containers 10, 20.

The worker may set, in the controller 80, the weight of the liquid raw material in a case in which the liquid amount in each of the containers 10, 20 is equal to or smaller than the predetermined value, for example. Alternatively, the weight of the liquid raw material in a case in which the liquid amount in each of the containers 10, 20 is equal to or smaller than the predetermined value may be set to a specified value in advance. In these cases, when the weight detected by each of the weight sensors 12, 22 reaches a set weight, it is determined that the liquid amount in the container 10 or the container 20 is equal to or smaller than the predetermined value, and the flow-path state of the switcher 40 is switched.

On the other hand, the worker may set, in the controller 80, the weight of the liquid raw material in a case in which the liquid amount in each of the containers 10, 20 is equal to or larger than the predetermined value, for example. Alternatively, the weight of the liquid raw material in a case in which the liquid amount in each of the containers 10, 20 is equal to or larger than the predetermined value may be set to a specified value in advance. In these cases, when the weight detected by each of the weight sensors 12, 22 reaches a set weight, it is determined that the liquid amount in the container 10 or the container 20 is equal to or larger than the predetermined value, and the flow-path state of the switcher 40 is switched.

### (5) EFFECTS

In the synthesis system 100 according to the present embodiment, gas is supplied from the gas supplier 30 to the container 10 through the flow-path portion 101, so that the liquid raw material contained in the container 10 is transported to the container 20 through the flow-path portion 103 and the synthesis reaction device 60. Further, gas is supplied from the gas supplier 30 to the container 20 through the flow-path portion 102, so that the liquid raw material contained in the container 20 is transported to the container 10 through the flow-path portion 103 and the synthesis reaction device 60. This operation is repeated, so that a sufficient amount of reactant is produced.

Here, it is possible to easily supply gas to the container 10 and easily supply gas to the container 20 by switching he flow-path state of the switcher 40. Therefore, the worker does not need to reconnect the gas supplier 30 to the container 10 or the container 20 every time. This can reduce a burden on the worker.

Further, in a case in which a predetermined switching condition is satisfied, the synthesis system 100 includes the controller 80 that switches the flow-path state of the switcher 40. This can more sufficiently reduce a burden on the worker. The switching condition may be that the liquid amount in the container 10 or the container 20 is equal to or smaller than a predetermined value, or may be that the liquid amount in the container 10 or the container 20 is equal to or larger than a predetermined value. In this case, the flow-path state of the switcher 40 can be easily switched at an appropriate point in time.

### (6) OTHER EMBODIMENTS

(a) While the controller 80 switches the flow-path state of each of the switchers 40, 50 in the above-mentioned embodiment, the embodiment is not limited to this. The worker may manually switch the flow-path state of each of the switchers 40, 50. Also in this case, the worker does not need to reconnect the gas supplier 30 to the container 10 or the container 20 every time. This can reduce a burden on the worker. With this configuration, the controller 80 does not include either of the switching controllers 86, 87.
(b) While the synthesis reaction device 60 is a photopolymerization reaction device in the above-mentioned embodiment, the embodiment is not limited to this. The synthesis reaction device 60 may be a reactor such as a plug flow reactor. In this case, the synthesis reaction device 60 produces a reactant from a liquid raw material by regulating the temperature, pressure and the like of the liquid raw material passing through the synthesis reaction device 60.
(c) While the sample supplier 70 replenishes a liquid raw material and adds a liquid additive in the above-mentioned embodiment, the embodiment is not limited to this. The sample supplier 70 may replenish a liquid raw material and does not have to add a liquid additive. In this case, the sample supplier 70 does not include any of the bottles 72 to 74 and the switcher 75.

Further, the sample supplier 70 may add a liquid additive and does not have to replenish a liquid raw material. In this case, the sample supplier 70 does not include the bottle 71. Further, the sample supplier 70 may be provided with only one of the bottles 72 to 74. In this case, the sample supplier 70 does not include the switcher 75.
(d) While a produced reactant is analyzed in the above-mentioned embodiment, the embodiment is not limited to this. A produced reactant does not have to be analyzed. In this case, the analysis device does not have to be connected to the switcher 50, and a separation device for collecting a produced reactant may be connected to the switcher 50. Further, in a case in which the container 10 or the container 20 containing a reactant is collected after production of a reactant, the switcher 50 does not have to be provided in the flow-path portion 103.

### (7) ASPECTS

It is understood by those skilled in the art that the plurality of above-mentioned illustrative embodiments are specific examples of the below-mentioned aspects.

(Item 1) A synthesis system according to one aspect may include a first flow-path portion connected to a first container in which a liquid raw material is containable, a second flow-path portion connected to a second container in which a liquid raw material is containable, a third flow-path portion which connects the first container and the second container to each other and to which a synthesis reaction device is connected, the synthesis reaction device producing a reactant from a liquid raw material, and a switcher that is switchable between a flow-path state in which gas supplied by a gas supplier is guided to the first flow-path portion and a flow-path state in which gas supplied by the gas supplier is guided to the second flow-path portion.

In this synthesis system, gas is supplied from the gas supplier to the first container through the first flow-path portion, whereby the liquid raw material contained in the first container is transported to the second container through the third flow-path portion and the synthesis reaction device. Further, gas is supplied from the gas supplier to the second container through the second flow-path portion, whereby the liquid raw material contained in the second container is transported to the first container through the third flow-path portion and the synthesis reaction device. This operation is repeated, so that a sufficient amount of reactant is produced.

Here, it is possible to easily supply gas to the first container and easily supply gas to the second container by switching the flow-path state of the switcher. Therefore, the worker does not need to reconnect the gas supplier to the first container or the second container every time. This can reduce a burden on the worker.

(Item 2) The synthesis system according to item 1, may further include a controller that switches a flow-path state of the switcher in a case in which a predetermined switching condition is satisfied.

In this case, a user of the synthesis system does not need to switch the flow-path state of the switcher. This can more sufficiently reduce a burden on the user.

(Item 3) The synthesis system according to item 2, wherein the switching condition may be that a liquid amount in the first container or the second container is equal to or smaller than a predetermined value.

In this case, the flow-path state of the switcher can be easily switched at an appropriate point in time.

(Item 4) The synthesis system according to item 2, wherein the switching condition may be that a liquid amount in the first container or the second container is equal to or larger than a predetermined value.

In this case, the flow-path state of the switcher can be easily switched at an appropriate point in time.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A synthesis system comprising:
a first flow-path portion connected to a first container in which a liquid raw material is containable;
a second flow-path portion connected to a second container in which a liquid raw material is containable;
a third flow-path portion which connects the first container and the second container to each other and to which a synthesis reaction device is connected, the synthesis reaction device producing a reactant from a liquid raw material; and
a switcher that is switchable between a flow-path state in which gas supplied by a gas supplier is guided to the first flow-path portion and a flow-path state in which gas supplied by the gas supplier is guided to the second flow-path portion.

2. The synthesis system according to claim 1, further comprising a controller that switches a flow-path state of the switcher in a case in which a predetermined switching condition is satisfied.

3. The synthesis system according to claim 2, wherein
the switching condition is that a liquid amount in the first container or the second container is equal to or smaller than a predetermined value.

4. The synthesis system according to claim 2, wherein
the switching condition is that a liquid amount in the first container or the second container is equal to or larger than a predetermined value.
